(19) United States
(12) Patent Application Publication
(10) Pub. No.: US 2015/0227492 A1
(43) Pub. Date: Aug. 13, 2015

(54) SYSTEMS AND METHODS FOR SELECTION AND LAYOUT OF MOBILE CONTENT ON IN-VEHICLE DISPLAYS

(71) Applicant: GM GLOBAL TECHNOLOGY OPERATIONS LLC, Detroit, MI (US)

(72) Inventors: FAN BAI, Ann Arbor, MI (US); DONALD K. GRIMM, Utica, MI (US); BO YU, Warren, MI (US)

(73) Assignee: GM GLOBAL TECHNOLOGY OPERATIONS LLC, Detroit, MI (US)

(21) Appl. No.: 14/175,120

(22) Filed: Feb. 7, 2014

(51) Int. Cl. G06F 17/21; G06F 3/0484

(52) U.S. Cl. CPC G06F 17/212; G06F 3/04847; G06F 3/04842

(57) ABSTRACT

An in-vehicle display system includes a selection tool, a memory for storing a number of style templates, and a rendering module. The rendering module is configured to select, in response to user input received via the selection tool, first content from a first data source associated with a mobile device within a vehicle, second content from a second data source, and a first style template from the set of style templates. The rendering module is further configured to render the first content and the second content on a first in-vehicle display based on the first style template.

### TECHNICAL FIELD

The technical field generally relates to vehicular display systems, and more particularly relates to systems and methods for specifying the content and layout of mobile device content within a vehicle.

### BACKGROUND

Modern vehicles, particularly automobiles, often incorporate one or more in-vehicle displays to provide user-interface functionality for various vehicle systems and subsystems, such as the navigation, climate control, infotainment, and other such systems accessible by the driver and/or passengers of the vehicle.

In recent years, there has been significant interest in utilizing mobile devices such as phones, tablets, and the like in combination with on-board systems, such as the in-vehicle display. Specifically, it is often desirable to project mobile device content (such as audio, video, games, etc.) onto the in-vehicle display so that it can be shared and more easily viewed by the passenger and (in some cases) the driver. In this way, a mobile device can itself be used as an in-vehicle infotainment system.

Such mobile device screen projection systems pose significant challenges, however. For example, it is difficult to select, organize, and display mobile device content from multiple devices, along with content from other data sources, on one or more displays within a vehicle.

Accordingly, it is desirable to provide improved systems and methods for selecting and controlling the layout of mobile device content on one or more displays. Furthermore, other desirable features and characteristics of the present invention will become apparent from the subsequent detailed description and the appended claims, taken in conjunction with the accompanying drawings and the foregoing technical field and background.

### SUMMARY

In accordance with one embodiment, an in-vehicle display method includes selecting first content from a first data source associated with a mobile device within a vehicle, selecting second content from a second data source, selecting a first style template from a set of style templates, and rendering the first content and the second content on a first in-vehicle display based on the first style template.

In another embodiment, an in-vehicle display system is provided. The in-vehicle display system includes a selection tool, a memory for storing a plurality of style templates; and a rendering module. The rendering module is communicatively coupled to the memory and the selection tool. The rendering module is configured to select, in response to user input received via the selection tool, first content from a first data source associated with a mobile device within a vehicle, second content from a second data source, and a first style template from the set of style templates. The rendering module is further configured to render the first content and the second content on a first in-vehicle display based on the first style template.

### DESCRIPTION OF THE DRAWINGS

The exemplary embodiments will hereinafter be described in conjunction with the following drawing figures, wherein like numerals denote like elements, and wherein:

FIG. 1 is a conceptual overview of an automotive interior useful in illustrating various embodiments.

FIG. 2 is a functional block diagram of in-vehicle display system in accordance with various exemplary embodiments.

FIG. 3 is a conceptual block diagram illustrating operation of an in-vehicle display system in accordance with exemplary embodiments.

FIGS. 4-6 depict example style templates in accordance with various embodiments.

FIG. 7 is a flow chart depicting a method in accordance with an exemplary embodiment.

### DETAILED DESCRIPTION

In general, the subject matter described herein relates to improved systems and methods for vehicle-based mobile device screen projection in which mobile device content (e.g., audio, video, text, haptic data, or the like) from one or more mobile devices is selectively rendered on one or more in-vehicle displays. In that regard, the following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

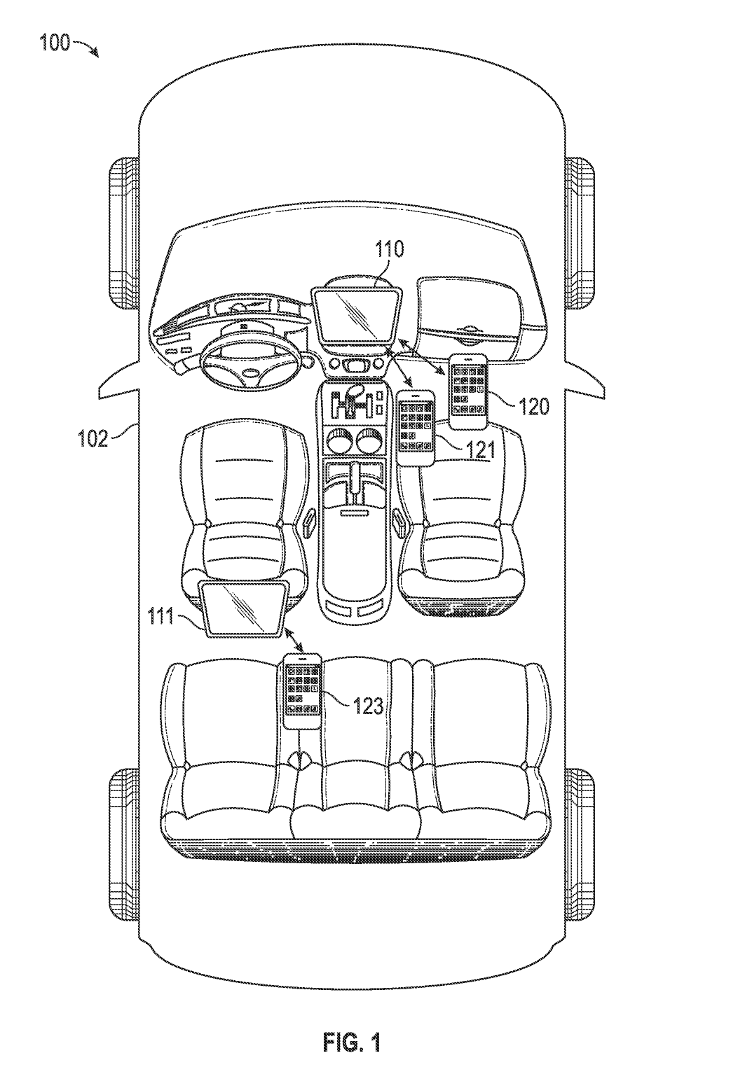

Referring now to FIG. 1, in accordance with exemplary embodiments of the subject matter described herein, a vehicle 100 includes one or more in-vehicle, integrated displays (or simply “displays”) 110 and 111. Display 110 (as well as display 111) may be utilized by a variety of systems, modules, and sub-modules within vehicle 100 (not illustrated) to provide an image viewable by the driver and/or passengers within the interior 102 of vehicle 100. For example, display 110 might typically be used in connection with a navigation system, a climate control system, a vehicle infotainment system, and/or the like. The following description may focus, without loss of generality, on display 110, but such description may also apply to display 111 and any additional displays that might be present within vehicle 100.

Display 110, which might be implemented as a liquid-crystal (LCD) display or any other such suitable display type known in the art, is illustrated in FIG. 1 as located in the center-front dash; however, the present disclosure is not so limited. The size, shape, orientation, and position of display 110 may vary depending upon, for example, the vehicle type, geometrical constraints, and the like. Furthermore, while display 110 is described as “integrated” into vehicle 100, in some embodiments display 110 might be removeably secured within the vehicle. As used in relation to display 110, the term “integrated” means that display 110 is configured to be used, in the ordinary course, as a part of vehicle 100 (as opposed to, for example, mobile device 120). In accordance with various embodiments, display 110 is a touch-screen display that allows users to interact with various subsystems of vehicle 100 using a variety of user interface display elements as is known in the art.

As illustrated, one or more mobile devices (e.g., mobile devices 120, 121, and 123) might be present within interior 102 of vehicle 100, including, for example, one or more smart-phones, tablets, laptops, feature phones, or other the like. In accordance with exemplary embodiments, each mobile device 120, 121, and 123 may be communicatively coupled to display 110 (and/or any additional displays) through one or more intervening modules, processors, etc. (not illustrated), and via a suitable wireless data connection, such as Bluetooth or WiFi. In this way, mobile device content such as music, images, video, and text generated by mobile devices 120-123 may be displayed, or “rendered”, on display 110. Various communication standards (such as MirrorLink/Miracast) have been developed to assist in such communication.

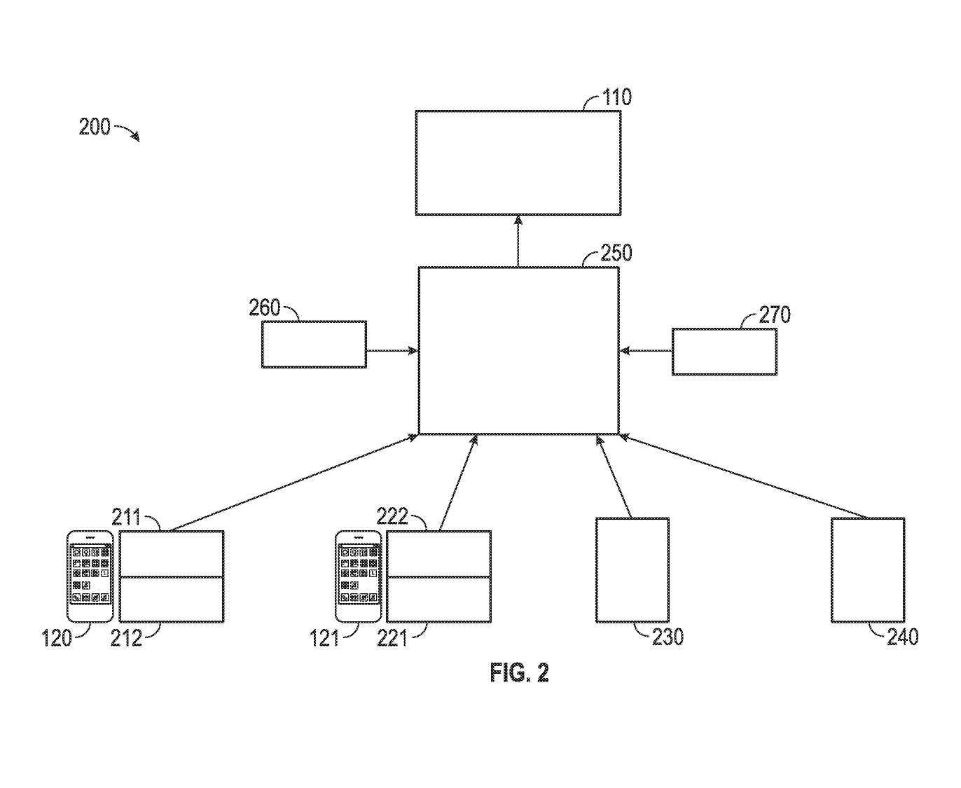

Referring now to FIG. 2 in combination with FIG. 1, an in-vehicle display system 200 generally includes the display 110, a rendering module 250, a selection and provisioning tool (or simply “selection tool”) 260, and a memory device 270 for storing a plurality of style templates, as described in further detail below. Rendering module 250 is configured to communicate, through any convenient data communication protocol, with various data sources, including (in the illustrated embodiment) mobile devices 120 and 121, controller area network (CAN) 230 (and any data sources connected thereto), and external network (e.g., Internet) content 240. In other embodiments, various other data sources might be available to rendering module 250.

Each mobile device 120, 121 might have more than one frame buffer associated with its display—i.e., a buffer of graphics data associated with a particular application running on the device. As will be understood, multiple such applications may run on a mobile device simultaneously. Thus, mobile device 120 is illustrated as having two frame buffers: 211 and 212, and mobile device 121 is also illustrated as having two frame buffers: 221 and 222. Each of these frame buffers 211, 212, 221, and 222 can be considered a separate data source. That is, data from multiple applications on a single mobile device 120, 121 may be substantially simultaneously projected (in a variety of ways) onto display 110. The term application may refer to an application as a whole, an application element (such as a window or view), or some other type of mobile device application component such as a widget, content provider, or broadcast receiver that is specific to the mobile operating system of the device.

In general, rendering module 250 comprises any combination of hardware and/or software configured to select, in response to user input received via selection tool 260 (i.e., a user interface implemented by selection tool 260), first content from a mobile device (e.g., mobile device 120), second content from a second data source (e.g., external network content 240), and a style template from the set of style templates stored within memory 270. Rendering module 250 is further configured to render the first content and the second content on in-vehicle display 110 based on the style template.

Mobile device content might include any of the various types of content (or output) produced by mobile devices 120, 121. In one embodiment, the mobile device content includes audio content. Such audio content might include, for example, music (stored within mobile device 120, 121 or streamed from an external source), spoken-word performances, audio podcasts, turn-by-turn directions, or the like. Similarly, mobile device content might include still or motion video content such as film video, television programming, video podcasts, map images, photographs, user interface images, and the like. Mobile device content might also include haptic feedback data—i.e., data indicating that some sort of haptic feedback (in the form of forces, vibrations, and/or motion) would typically be provided, in that context, to the user. Mobile device content might also include application metadata, i.e., data indicating which application within mobile device is producing particular mobile device content. In yet another embodiment, mobile device content includes simple text data (e.g., status messages) to be rendered onto display 110. In situations where a direct mapping of the mobile device content to an integrated display cannot be achieved due to limitations on the destination device, adaptation logic can be defined to effectively render the content on the vehicle display (for example, graphical information from the mobile device can be rendered as text on the destination device, or warning graphics on the mobile device can be rendered on an LED alert display using color or flashing techniques).

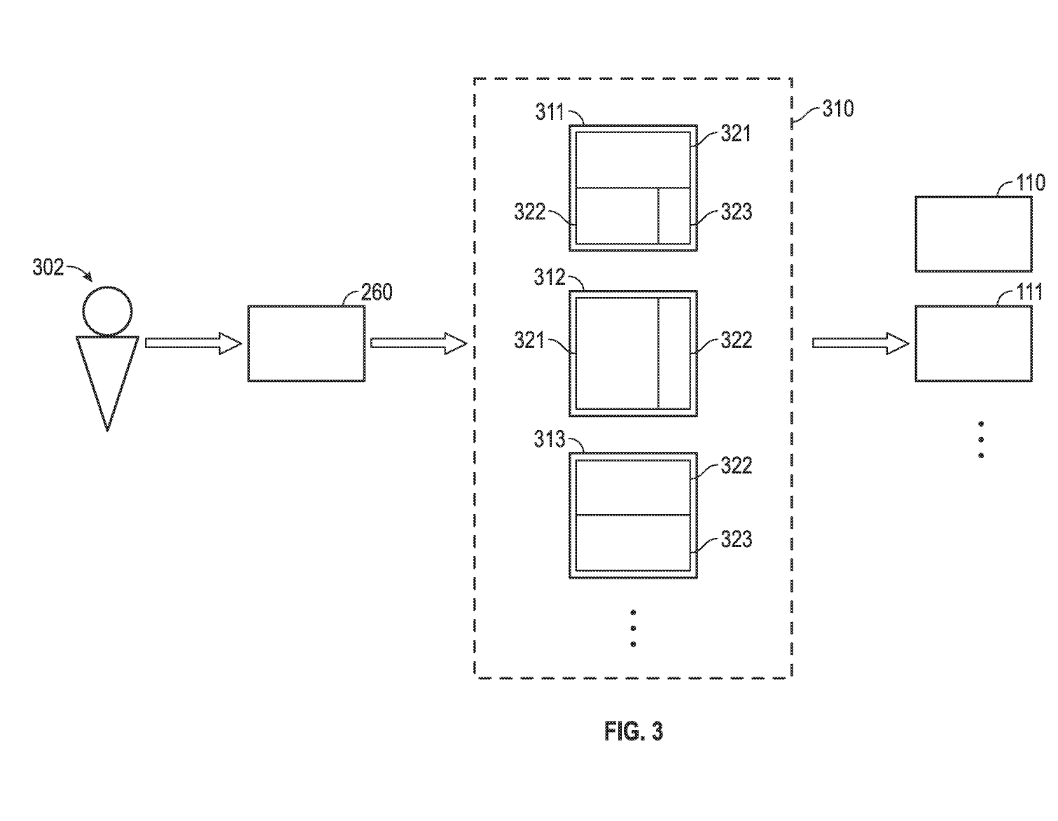

Referring now to the conceptual overview depicted in FIG. 3, in conjunction with the system illustrated in FIG. 2, a user 302 (e.g., a driver, passenger, or the like) utilizes selection tool 260 to select a particular display style template (311, 312, 313, etc.) from a set 310 of such style templates (e.g., stored in memory device 270 of FIG. 2). The user also utilizes selection tool 260 to select a particular in-vehicle display (110, 111, etc.) upon which to render the selected content in accordance with the selected style template. This process may be repeated, if desired, for each remaining display (e.g., display 111). Thus, for example, the user may choose to display different content (e.g., a mix of mobile device content and vehicle infotainment content) using the same style template, display the same content using the same style template, or display the same content using different style templates on the displays 110, 111.

As illustrated, each style template specifies how displayed content (shown as items 321, 322, and 323) is to be organized geometrically on display 110. For example, style template 311 as illustrated includes a long rectangular region for displaying content 321 above a pair of side-by-side rectangular regions for displaying content 322 and 323. Similarly, style template 312 includes two side-by-side rectangular regions for displaying two types of content: content 321 and 322. Finally, style template 313 includes two vertically stacked rectangles for displaying content 322 and 323.

Style templates 311, 312, etc. may be stored in any convenient data format that includes a set of style attributes sufficient to render the desired content. For example, the style attributes might include one or more of the shape, size, location, type, and data source(s) associated with each template. For example, the style templates may be stored in an Extensible Markup Language (XML) form and/or via Cascading Style Sheets (CSS).

Any given style template 311, 312, 313 may be agnostic with respect to the particular content that is to be displayed (allowing the user to specify which content is displayed in which region) or may specify or be provided with a default setting for particular content to be displayed. Thus, for example, style template 312 may specify that audio information (e.g., the currently-playing track) should be used as content 322, and that navigational information, such as a real-time map, be used as content 321. In other embodiments, some but not all regions are provided with default settings. Style sheets might also be user-defined.

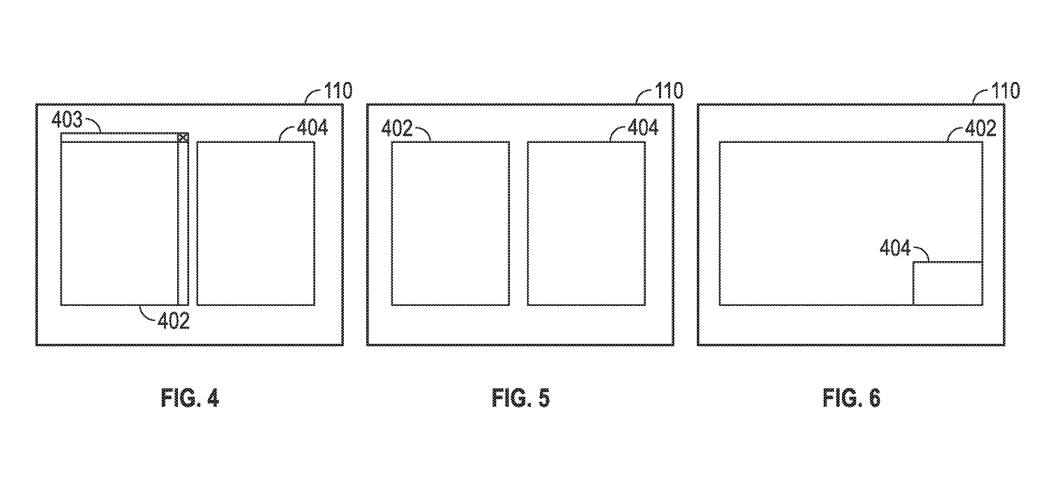

FIGS. 4-5 depict various example style templates (410, 510, and 610, respectively). FIG. 4 depicts an example of a “framing” rendering mechanism. That is, content 404 is rendered in a constant-sized rectangle, while content 402 is rendered within a rectangular region including conventional window controls manipulatable by the user, such as a slider bar 403, a “close window” button, or the like. FIG. 5 depicts a “windowing” rendering mechanism in which two constant-sized rectangular regions (without window controls) are used to display content 402 and 404. Finally, FIG. 6 depicts an “overlay” rendering mechanism in which one rectangular region (for content 404) partially overlaps the larger rectangular region used for displaying content 402. The framing mechanism also enables the user to modify the layout of the individual frames on the vehicle display (i.e., frames can be resized, hidden, closed, or overlaid on top of one another). In situations where a frame is hidden, the z-order (level) of a frame could be changed by the mobile device based on a event condition that is communicated from the mobile device (i.e., the frame could be brought to the top). The overlay mechanism could enable a direct-mapping style overlays (i.e., a mobile device could overlay different map layers such as points of interest or traffic events onto the existing vehicle map display) or a widget style overlay where content is rendered in a shape and style that does not interfere with the content of the vehicle display. Techniques such as transparency could be used to facilitate an overlay that minimizes interference with the vehicle display.

Referring again to FIG. 2, as mentioned previously, selection tool 260 includes any suitable form of user interface for carrying out the selection of templates, content, and displays. In one embodiment, the user interface is implemented as a touch-screen graphical user interface provided, for example, by the front side display 110 of FIG. 1. In other embodiments, the user interface is implemented at one or more additional displays (e.g., 111) and/or by an application running on mobile device 120 or 121. Regardless of how the user interface is implemented, the user is provided with a convenient way to select the content and style template(s) to be used. The style templates may be shown graphically (as shown in FIG. 3) so that the user may visualize the relative placement of content. The user interface may allow the user to scroll through these visualizations and then select them using the touch interface. Selection of the content to be rendered may similarly be listed for the user in a convenient fashion. Other selection alternatives include vehicle selection controls such as steering wheel control dials or knobs, center console mounted rotating dials, knobs or joysticks, voice commands or automatic selection based on driver state (as determined by in-vehicle sensors such as driver monitoring systems or biometric measurement systems), vehicle state (as determined by vehicle sensors such as braking, steering and throttle control systems) and/or external environmental state (as determined by vehicle sensors that monitor external traffic movements or monitor road condition state).

In some embodiments, the manufacturer of the vehicle can limit or otherwise exercise control over the set of style templates 310 that are allowed for displaying mobile content in the vehicle. In this way, the mobile device user experience may effectively be converted into a vehicle-manufacturer user experience. Style templates may be restricted for context reasons (i.e., dangerous driving context, information not useful/appropriate for current driving context) or for policy reasons (i.e., not allowed by local administrator or by regional authority). Similarly, style templates may be enabled based on current context (mobile device has indicated heavy traffic ahead) or service usage (incoming phone call received or user is participating in an online meeting). Another example of context that enables a particular style template would include location based services (e.g., vehicle entering road-pricing location may invoke a style template that display current travel costs).

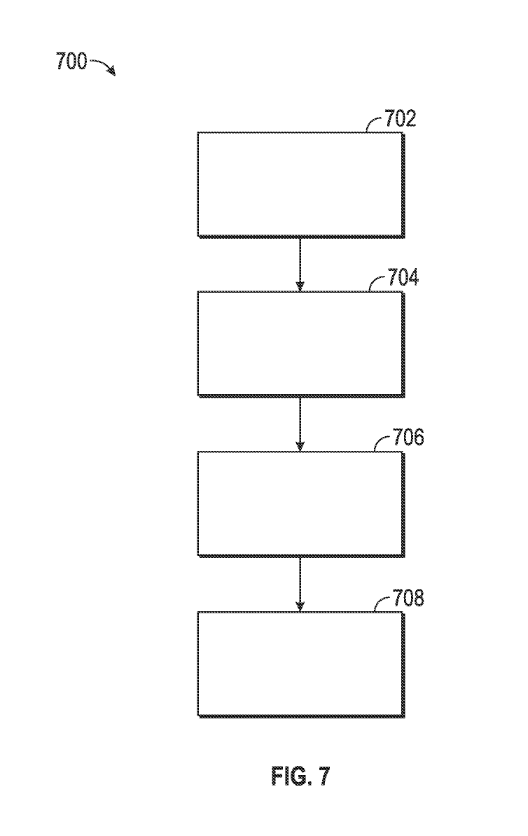

FIG. 7 is a flowchart depicting a method in accordance with one embodiment. While the illustrated method is shown as including four steps (702-708), it will be appreciated that additional and/or intervening steps may be performed in various implementations. Briefly, referring now to FIG. 7, and with continuing reference to FIGS. 1-3, at 702, content is selected—i.e., first content from a first data source associated with a mobile device within (or otherwise in communication with) the vehicle (e.g., mobile device 120 or 121 of FIG. 2). The mobile device content might include, for example, video content, audio content, application metadata, and haptic data. Next, at 704, second content from a second data source is selected (e.g., data sources 230 or 240 in FIG. 2). At 706, a first style template is selected from a set of style templates (e.g., style template 311 of FIG. 3). Finally, at 708, the first content and the second content are substantially simultaneously rendered on a first in-vehicle display (e.g. display 110 or display 111) based on the selected first style template. Steps 702-708 may then be repeated for additional displays, if desired.

While the example templates illustrated in FIGS. 3-6 show generally rectilinear display areas, the various teachings of the present disclosure is not so limited and contemplates that a wide range of geometries (curvilinear, etc.) may be used for displaying the content. Similarly, while the figures depict regions with little or no space between them, any desired spacing may be employed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An in-vehicle display method comprising:
selecting first content from a first data source associated with a mobile device within a vehicle;
selecting second content from a second data source;
selecting a first style template from a set of style templates; and
rendering the first content and the second content on a first in-vehicle display based on the first style template.

2. The method of claim 1, further including:
selecting a second style template from the set of style templates; and
rendering the first content and the second content on a second in-vehicle display based on the second style template substantially simultaneously with the rendering of the first content.

3. The method of claim 1, further including rendering the first content and the second content on a second in-vehicle display based on the first style template substantially simultaneously with the rendering of the first content.

4. The method of claim 1, wherein the second data source corresponds to a controller area network.

5. The method of claim 1, wherein the second data source corresponds to an external network.

6. The method of claim 1, wherein the set of style templates implement at least one of framing, windowing, and overlaying of content.

7. The method of claim 1, wherein the first content includes at least one of video content, audio content, application metadata, and haptic data.

8. An in-vehicle display system comprising:
a selection tool;
a memory for storing a plurality of style templates; and
a rendering module communicatively coupled to the memory and the selection tool, the rending module configured to:
select, in response to user input received via the selection tool, first content from a first data source associated with a mobile device within a vehicle, second content from a second data source, and a first style template from the set of style templates; and
render the first content and the second content on a first in-vehicle display based on the first style template.

9. The system of claim 8, wherein the rendering module is further configured to select a second style template from the set of style templates, and render the first content and the second content on a second in-vehicle display based on the second style template substantially simultaneously with the rendering of the first content.

10. The system of claim 8, wherein the rendering module is further configured to render the first content and the second content on a second in-vehicle display based on the first style template substantially simultaneously with the rendering of the first content.

11. The system of claim 8, wherein the second data source corresponds to a controller area network.

12. The system of claim 8, wherein the second data source corresponds to an external network.

13. The system of claim 8, wherein the set of style templates implement at least one of framing, windowing, and overlaying of content.

14. The system of claim 8, wherein the first device content includes at least one of video content, audio content, application metadata, and haptic data.

15. A non-transitory computer-readable media bearing software instructions configured to cause a processor to perform the steps of:
selecting first content from a first data source associated with a mobile device within a vehicle;
selecting second content from a second data source;
selecting a first style template from a set of style templates; and
rendering the first content and the second content on a first in-vehicle display based on the first style template.

16. The non-transitory computer-readable media of claim 15, wherein the software instructions are further configured to cause the processor to select a second style template from the set of style templates; and to render the first content and the second content on a second in-vehicle display based on the second style template substantially simultaneously with the rendering of the first content.

17. The non-transitory computer-readable media of claim 15, wherein the software instructions are further configured to cause the processor to render the first content and the second content on a second in-vehicle display based on the first style template substantially simultaneously with the rendering of the first content.

18. The non-transitory computer-readable media of claim 15, wherein the second data source corresponds to an external network.

19. The non-transitory computer-readable media of claim 15, wherein the set of style templates implement at least one of framing, windowing, and overlaying of content.

20. The non-transitory computer-readable media of claim 15, wherein the mobile device content includes at least one of video content, audio content, application metadata, and haptic data.
